(19) United States
(12) Patent Application Publication
(10) Pub. No.: US 2008/0307863 A1
(43) Pub. Date: Dec. 18, 2008

(54) PENETROMETER INCLUDING A HAMMER AND AN AUTOMATED ACTUATOR WEIGHT-SUPPORTED BY AN ANVIL THROUGH THE HAMMER

(76) Inventor: Joel Sercel, Lake View Terrace, CA (US)

Correspondence Address: STETINA BRUNDA GARRED & BRUCKER, 75 ENTERPRISE, SUITE 250, ALISO VIEJO, CA, 92656, US

(21) Appl. No.: 11/762,914

(22) Filed: Jun. 14, 2007

(51) Int. Cl. G01N 3/00

(52) U.S. Cl. 73/84; 73/81

(57) ABSTRACT

A penetrometer that includes a hammer, an anvil, a penetrating rod, and an automated actuator. The penetrating rod extends from the anvil with the anvil between the hammer and the penetrating rod. The automated actuator is engaged with the hammer and configured to reciprocally impact the hammer against the anvil. The automated actuator is weight-supported by the anvil through the hammer with the penetrometer positioned with the automated actuator above the anvil and upon impact of the hammer against the anvil.

### REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention generally relates to penetrometers, and more particularly, to a penetrometer that includes a hammer and an electrical actuator weight-supported by an anvil through the hammer.

2. Related Art

A method used to determine soil hardness/density is dynamic cone penetration testing. In this test a penetrometer is provided that includes a penetrating rod that includes a distally disposed penetrating cone. The penetrating cone is inserted into the soil being tested. A fixed weight, referred to as a hammer, is dropped from a predetermined distance onto an impact surface, referred to as an anvil, of the penetrating rod. The number of impacts required to advance the penetrating cone for a predetermined depth into the soil is an index of the hardness/denseness of the soil.

In a simple arrangement, the hammer may be manually lifted and dropped. However, where there is a multiplicity of test sites and/or time is of a concern, this manual arrangement is lacking. As such, in other arrangements, the repeated hammer movement may be automated through the use of an actuator. The actuator is engaged with the hammer. Such automated penetrometers require a structural support for the actuator. The penetrometer includes a housing to which the actuator is attached. The actuator may be offset to one side of the penetrating rod. The hammer is engaged with the actuator. The housing must have sufficient mass and configuration to provide a reaction mass to the hammer when impacting against the anvil. In addition, the housing is used to support the anvil and penetrating rod, as well as, the overall penetrometer. In addition, the actuator may be electrical in nature. An electrical actuator would require a power source, such as a battery. To the extent that the power source is housed onboard with the penetrometer, the housing must also be structurally supportive of the power source as well.

The various requirements of the support structure of the penetrometer tend to result in prior art penetrometer designs that are relatively large, bulky and/or heavy. These prior art devices do not lend themselves to be rapidly deployed and redeployed. Accordingly, there is a need in the art for an improved penetrometer design.

### BRIEF SUMMARY

According to an aspect of the present invention, there is provided a penetrometer. The penetrometer includes a hammer, an anvil, a penetrating rod, and an automated actuator. The penetrating rod extends from the anvil with the anvil between the hammer and the penetrating rod. The automated actuator is engaged with the hammer and configured to reciprocally impact the hammer against the anvil. The automated actuator is weight-supported by the anvil through the hammer with the penetrometer positioned with the automated actuator above the anvil and upon impact of the hammer against the anvil.

According to various embodiments, the hammer may include a shaft and a head distally disposed between the shaft and the anvil. The shaft may be engaged with the automated actuator. The automated actuator may be electrical in nature. The automated actuator may be a solenoid device. The automated actuator may include a control module, and the control module may be weight-supported by the anvil through the hammer with the penetrometer positioned with the control module above the anvil and upon impact of the hammer against the anvil. The automated actuator may include a power source, and the power source may be weight-supported by the anvil through the hammer with the penetrometer positioned with the power source above the anvil and upon impact of the hammer against the anvil.

In addition, the penetrometer may further include a guiding support slidably engaged with the automated actuator. The guiding support may include two guiding support elements each being slidably engaged with the automated actuator. The guiding support may be rod-shaped. The guiding support may be slidably, engaged with the anvil. The automated actuator is weight-supported by the anvil with the penetrometer positioned with the automated actuator above the anvil and with the hammer not in contact with the anvil. The penetrometer may further include a spacer element engaged with the automated actuator disposed between the automated actuator and the anvil. The automated actuator may be weight-supported by the anvil through the spacer element with the penetrometer positioned with the automated actuator above the anvil. The penetrometer may further include a spring disposed between the spacer element and anvil, and the automated actuator may be weight-supported by the anvil through the spring with the penetrometer positioned with the automatedactuator above the anvil. The spring may be coiled about the guiding support.

According to another aspect of the invention, there is provided a penetrometer. The penetrometer includes a hammer, an anvil, a penetrating rod, and an automated actuator. The penetrating rod extends from the anvil with the anvil between the hammer and the penetrating rod. The automated actuator is engaged with the hammer and configured to reciprocally impact the hammer against the anvil. The automated actuator is weight-supported by the anvil with the penetrometer positioned with the automated actuator above the anvil and with the hammer not in contact with the anvil.

According to various embodiments, the penetrometer may further include a spacer element engaged with the automated actuator disposed between the automated actuator and the anvil. The automated actuator may be weight-supported by the anvil through the spacer element with the penetrometer positioned with the automated actuator above the anvil. The penetrometer further includes a spring that is disposed between the spacer element and anvil, the automated actuator being weight-supported by the anvil through the spring with the penetrometer positioned with the automated actuator above the anvil. The penetrometer may further include a spring disposed between the automated actuator and the anvil, and the automated actuator may be weight-supported by the anvil through the spring with the penetrometer positioned with the automated actuator above the anvil.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a penetrometer as disassembled in a portion of a carrying case;

FIG. 2 is a perspective view of the penetrometer;

FIG. 3 is a side view of the penetrometer deployed upon a ground location of a ground with a hammer in an intermediate position away from an anvil;

FIG. 4 is the side view of the penetrometer of FIG. 3 with the hammer against the anvil;

FIG. 5 is the side view of the penetrometer of FIG. 4 with a penetrating rod inserted into the ground; and

FIG. 6 is the side view of the penetrometer of FIG. 5 with an extension penetrating rod inserted into the ground.

### DETAILED DESCRIPTION

The detailed description set forth below in connection with the appended drawings is intended as a description of the presently preferred embodiment of the invention, and is not intended to represent the only form in which the present invention may be developed or utilized.

It is understood that the use of relational terms such as first, second, and the like are used solely to distinguish one from another entity without necessarily requiring or implying any actual such relationship or order between such entities.

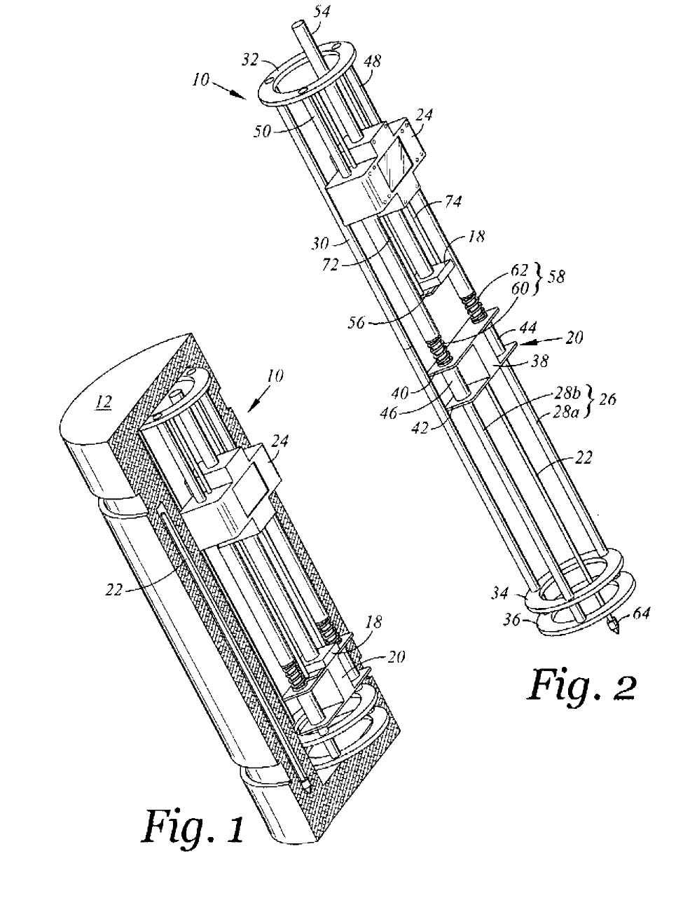

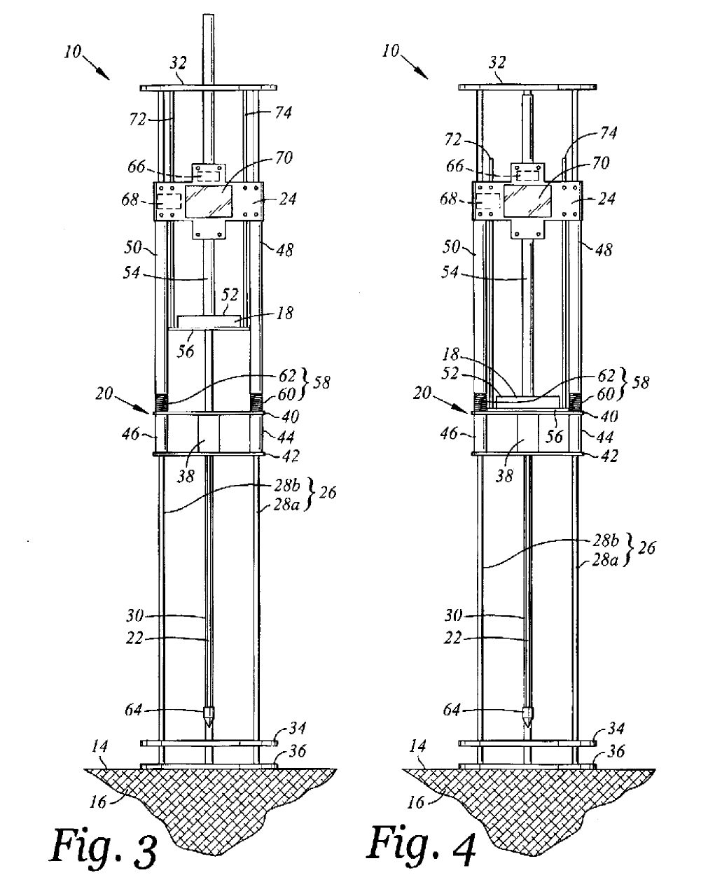

With reference now to FIG. 1, an exemplary penetrometer 10 is shown disassembled as stored in a half of a carrying case 12. FIG. 2 is a perspective view of the penetrometer 10 as assembled. FIG. 3 is a side view of the penetrometer 10 as disposed adjacent a soil surface 14 of soil 16 being tested for hardness/density.

In accordance with an aspect of the present invention, there is provided the penetrometer 10. The penetrometer 10 includes a hammer 18, an anvil 20, a penetrating rod 22, and an automated actuator 24. The penetrating rod 22 extends from the anvil 20 with the anvil 20 between the hammer 18 and the penetrating rod 22. The electrical actuator 24 is engaged with the hammer 18 and configured to reciprocally impact the hammer 18 against the anvil 20. The automated actuator 24 is weight-supported by the anvil 20 through the hammer 18 with the penetrometer 10 positioned with the automated actuator 24 above the anvil 20 and upon impact of the hammer 18 against the anvil 20. It is contemplated that with this configuration, during operation of the penetrometer 10, the automated actuator 24 is a reaction mass to the impacting hammer 18 against the anvil 20.

According to various embodiments, the penetrometer 10 may further include a guiding support 26 slidably engaged with the automated actuator 24. The guiding support 26 may include first and second guiding support elements 28a, 28b each being slidably engaged with the automated actuator 24. The guiding support 26 may be rod-shaped, with each of the guiding support elements 28a, 28b being rod-shaped. The guiding support 26 may be of other sizes, shapes and cross-sections as may be chosen from those well known to one of ordinary skill in the art, such as an elongate bar shape with a rectangular cross section for example. The automated actuator 24 may have openings formed there through to accommodate the guiding support elements 28a, 28b. While such openings are of a closed nature, other configurations are contemplated, such as a groove or slot.

The penetrometer 10 may further include an additional support element 30. In this embodiment, the guiding support elements 28a, 28b and the additional support element 30 are parallel to each other, and are all commonly attached to a top ring 32 and first and second bottom rings 34, 36. The second bottom ring 36 may function as a base for the overall penetrometer 10. The guiding support elements 28a, 28b, the additional support element 30, the top ring 32 and the first and second bottom rings 34, 36 collectively provide structural support for the overall penetrometer 10. It is understood that other arrangements may be implemented for providing sufficient structural support for the penetrometer 10 which may be chosen from those which are well know in the art. In addition, though not depicted, the carrying case 12 may be modified to serve a dual function of a portion of a housing and/or sound baffle.

In the embodiment shown, the anvil 20 includes a central section 38, top and bottom plates 40, 42, and first and second spacer sections 44, 46. The first and second spacer sections 44, 46 are disposed between the top and bottom plates 40, 42.

The guiding support 26 may be slidably engaged with the anvil 20. In this embodiment, each of the first and second guiding support elements 28a, 28b is slidably engaged with the anvil 20. The anvil 20 may have openings formed there through to accommodate the guiding support elements 28a, 28b. Such openings are formed through the top and bottom plates 40, 42. While such openings are of a closed nature, other configurations are contemplated, such as a groove or slot. The first and second spacer sections 44, 46 respectively receive the first and second guiding support elements 28a, 28b. The anvil 20 may be of other sizes, shapes and cross-sections as may be chosen from those well known to one of ordinary skill in the art, such as more solid brick-like configuration for example.

The penetrometer 10 may further include a spacer element, which may be in the form of first and second spacer elements 48, 50. The first and second spacer elements 48, 50 are engaged with the automated actuator 24 and disposed between the automated actuator 24 and the anvil 20. The first and second spacer elements 48, 50 may be utilized to off-set the relative location of the automated actuator 24 to the anvil 20.

The penetrometer 10 may further include a spring 58 disposed between the automated actuator 24 and the anvil 20. In this embodiment, the spring 58 includes first and second spring segments 60, 62. The first and second spring segments 60, 62 are respectively disposed between the first and second spacer elements 48, 50 and the anvil 20. In this embodiment, the spring 58 is a helical compression spring, with the first and second spring segments 60, 62 respectively coiled about the guiding support elements 28a, 28b. The size, spring type, number of components and configuration of the spring 58 may be chosen from those which are well know to one of ordinary skill in the art. For example, spring segments may be disposed internally within the guiding support elements 28a, 28b.

The hammer 18 may include a head 52, a shaft 54, and an impact plate 56. The head 52 is distally disposed at the shaft 54. The shaft 54 is engaged by the electrical actuator 24. The impact plate 56 is between the head 52 and the anvil 20. The impact plate 56 is configured to impact the anvil 20 upon actuation of the hammer 18 by the automated actuator 24. The hammer 18 may be of other sizes, shapes and cross-sections as may be chosen from those well known to one of ordinary skill in the art. Design considerations would include determination of sufficient mass to achieve a desired force and/or momentum in order to conduct the particular hardness or density testing or installation process undertaken.

As used herein the term “automated” of the term “automated actuator 24” refers to the automated actuator 24 having the ability to repeatedly impart force to cause to the hammer 18 to impact against the anvil 20 a series of times without human or manual interaction (other than first initiating of the series of times of impacts). For example, the automated actuator 24 may be a solenoid device. A user may initially press of button or flip a switch to initiate an electrical control of the solenoid with the solenoid thereafter repeatedly driving the hammer 18 in a reciprocal manner against the anvil 20. It is noted that repeated impacts of the hammer 18 against the anvil 20 solely due to gravity in the case of the hammer 18 bouncing up and down against anvil 20 would not be considered to be automated in nature. It is understood that the hammer 18 may indeed repeated impact the anvil 20 due to gravity in such a manner, however, the automated actuator 24 may be automated in nature so long as the automated actuator 24 later again imparts force to cause to the hammer 18 to impact against the anvil 20. Thus, a motor may be used to repeatedly raise the hammer 18 which drops against the anvil 20 via gravity and this would be considered automated in nature.

The automated actuator 24 may be electrical in nature. In this context, as used herein, the term “electrical” refers to having a component which is electrical-based either in regards to the mechanism that provides a force for movement of the hammer 18 or the triggering/control device for a movement mechanism. For example, a mechanism that provides a force for movement of the hammer 18 may be a solenoid device that includes electrical windings that generates force in response to electrical current being applied. In another context the automated actuator 24 may include a mechanism that provides a force for movement of the hammer 18 that is not itself electrical in nature and also includes a triggering or control device for the movement mechanism. For example, a mechanism that provides a force for movement of the hammer 18 may be a hydraulic device that is triggered or controlled by an electric valve.

The automated actuator 24 may be a mechanism that provides a force for movement of the hammer 18 that is of a linear nature, such as a solenoid device. Other arrangements are contemplated which may be chosen from those of ordinary skill in the art and may include rotating or pivoting components such as a voice coil motor for example. In other arrangements, a mechanism that provides a force may be based upon fluid or gas pressure. The various components of the mechanism that provides such force may be on-board or located remotely from the penetrometer 10. However, by locating such components to be weight-supported by the anvil 20 through the hammer 18 with the penetrometer 10 positioned with the automated actuator 24 above the anvil 20 and upon impact of the hammer 18 against the anvil 20 this adds the mass of such components to the reaction mass of the impacting hammer 18.

The automated actuator 24 may include a control module 66 and a power source 68 (each shown in phantom lining as it is understood that such components may be housed within a housing of the automated actuator 24). In addition, the automated actuator 24 may include a display 70. The display 70 is in electrical communication with the control module 66. It is contemplated that the display 70 may be configured to interface the control module 66 with the user for input and/or output. It is contemplated that in other arrangements the control module 66, the power source 68 and/or the display 70 may be located at other locations about the penetrometer 10 as well as off-board the penetrometer 10. However, by locating such components to be weight-supported by the anvil 20 through the hammer 18 with the penetrometer 10 positioned with the automated actuator 24 above the anvil 20 and upon impact of the hammer 18 against the anvil 20 this adds the mass of such components to the reaction mass of the impacting hammer 18. The control module 66 may be configured to maintain data with regards to the number of cycles that the hammer 18 impacts the anvil 20, the force or power output of the automated actuator 24, the indexing of the automated actuator 24 with respect to the guiding support elements 28a, 28b, and/or the indexing of the shaft 54 with respect to the automated actuator 24 so as to determine a depth of the penetrating rod 22 into the soil 16. Such data may be utilized to determine a soil hardness or density for example. The penetrometer 10 may be utilized for other purposes such as for the collection of soil core samples, the placement of sensors into the soil 16, installation of tie-down anchors, and installation of electrical grounding rods, for examples.

The automated actuator 24 may interface with the hammer 18 in a variety of ways. In the particular embodiment depicted, the automated actuator 24 drives the hammer 18 via the shaft 54. The automated actuator 24 and the shaft 54 are cooperatively sized and configured to engage one another. In this regard, the shaft 54 may include surface features to facilitate such engagement. In addition, the automated actuator 24 and/or the shaft 54 may include features to mitigate against a backlash motion of the shaft 54 immediately after impact of hammer 18 against the anvil 20.

The penetrating rod 22 may include a cone tip 64. The cone tip 64 is distally disposed at an end of the penetrating rod 22 and is used to initially pierce the soil surface 14 and be inserted to the soil 16. The sizing, angulation and configuration of cone tip 64 may be chosen from those which are well known to one of ordinary skill in the art. This selection may be influenced based upon standardized testing procedures with respect to the particular soil hardness or density testing being performed.

Referring now to the side views of the penetrometer 10 as seen in FIG. 3-6 there is depicted an exemplar sequence of positions of the penetrometer 10 during operation. The penetrometer 10 is in an upright position with the penetrating rod 22 generally disposed orthogonal to the soil surface 14 being penetrated. The electrical actuator 24 and hammer 18 are located above the anvil 20.

FIG. 3 depicts the penetrometer 10 with the hammer 18 in a partially elevated position. In this position, the hammer 18 is not in contact with the anvil 20, as the impact plate 56 is not in contact with the anvil 20. However, it is noted that the hammer is indeed weight-supported by the anvil 20. In this regard, the hammer 18 is weight-supported by the anvil 20 through the automated actuator 24, the first and second spacer elements 48, 50, and the first and second spring segments 60, 62.

Referring now to FIG. 2, the impact plate 56 of the hammer is shown in contact with the anvil 20. This figure is representative of the hammer 18 at the moment of impact upon the anvil 20 as actuated by the automated actuator 24. In this regard, at such instance, the hammer 18 is exerting a downward force upon the anvil 24. The automated actuator 24 provides a reaction mass to counter such downward force. As mentioned above, the automated actuator 24 is weight-supported by the anvil 20 through the hammer 18 with the penetrometer 10 positioned with the automated actuator 24 above the anvil 20 and upon impact of the hammer 18 against the anvil 20. As used herein the term weight-supported refers to having at least some portion of the subject object having its weight against an object with such object resisting the weight of the subject object. Such a configuration is advantageous as the mass of the electrical actuator 24 provides the reaction mass to the impacting hammer 18. This avoids having to mount the automatedactuator 24 to a housing or other arrangement which may tend to result in the overall device being bulky, complex and/or weighty.

The weight of the automated actuator 24 is initially borne by the first and second spacer elements 48, 50 and first and second spring elements 60, 62, and then shifted to being borne by the hammer 18 during impact. It is understood that the entire weight of the automated actuator 24 need not be either borne by either of the first and second spacer elements 48, 50 and first and second spring elements 60, 62 or the hammer 18. In addition, it is contemplated that some of the weight of the electrical actuator 24 may be supported by the guiding support elements 28a, 28b due to friction with the electrical actuator 24 and the first and second spacer elements 48, 50 (to the extent that the first and second spacer elements are attached to the automated actuator 24).

After impacting the anvil 20, the hammer 18 may be moved upward by the automated actuator 24 to complete a cycle. The weight of the hammer 18 and the automated actuator is shifted back to being borne by the first and second spacer elements 48, 50 and first and second spring elements 60, 62. It is contemplated that the spring 58 provides a shock and/or motion attenuation function during this reciprocating cycle of shifting weight support. Also this avoids the first and second spacer elements 48, 50 from bouncing against the anvil 20. Thus, the above-described weight support may be shifted in smooth and controlled manner.

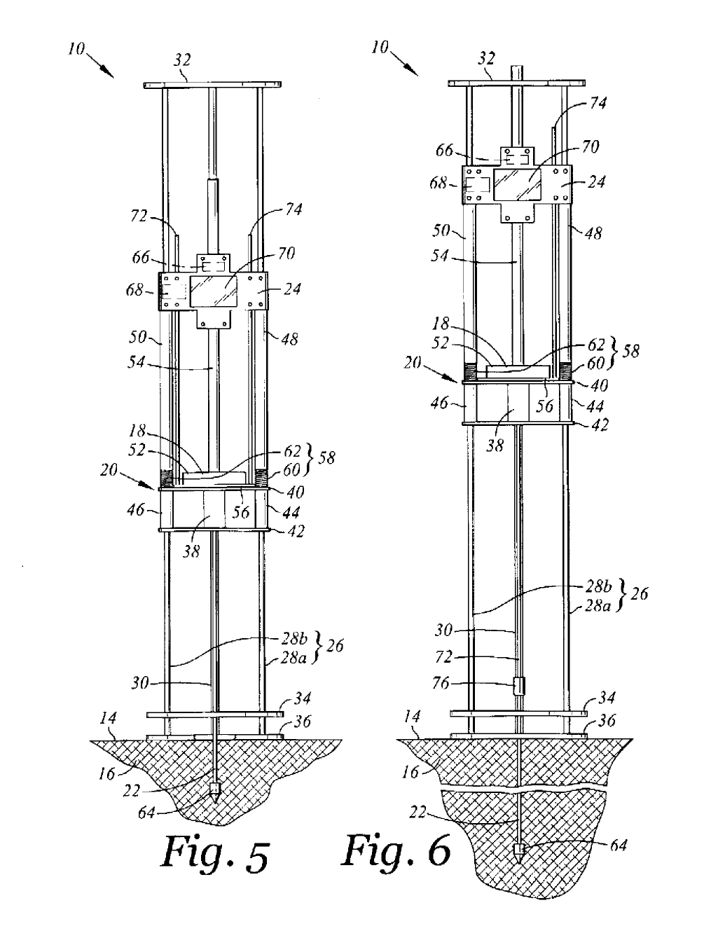

Referring now to FIG. 5, there is depicted the penetrometer 10 with a portion of the penetrating rod 22 embedded in the soil 16. In this regard, it is assumed that the hammer 18 has been repeatedly impacted against the anvil 20 by the electrical actuator 24. The anvil 20 is positioned lower than its previous starting position. Likewise the relative positioning of the hammer 18 and the automated actuator 24 are also positioned lower as slid along the guiding support elements 28a, 28b.

The penetrometer 10 may include first and second extension rods 72, 74 which may be stored by being attached to the impact plate 56. Referring now to FIG. 6, the penetrometer 10 is depicted with the first extension rod 72 attached to the anvil 20. The first extension rod 72 may be joined with the penetrating rod 22 through the use of an extension coupler 76. As such the first and second extension rods 72, 74 may be used to achieve varying depths of the cone tip 64 as may be required by the subject testing or installation being performed.

According to another aspect of the invention, there is provided the penetrometer 10 for soil hardness testing. The penetrometer 10 includes the hammer 11, the anvil 20, the penetrating rod 22, and the automated actuator 24. The penetrating rod 22 extends from the anvil 20 with the anvil 20 between the hammer 18 and the penetrating rod 22. The automated actuator 24 is engaged with the hammer 18 and configured to reciprocally impact the hammer 18 against the anvil 20. In this embodiment, the automated actuator 24 is weight-supported by the anvil 20 with the penetrometer 10 positioned with the automated actuator 24 above the anvil 20 and with the hammer 18 not in contact with the anvil 20.

In addition, the anvil 20 may be cooperatively engaged with the guiding support elements 28a, 28b so as to selectively facilitate a one-way movement. Though not shown this may be accomplished with the use of a simple plate with two through-holes disposed at a top side of the anvil 20 about the guiding support elements 28a, 28b. The plate may be angularly disposed such that inner diameters of the through-holes effectively lock the plate with the guiding support elements 28a, 28b preventing the anvil 20 from moving upward. The plate may be released by positioning the plate to be horizontal (orthogonal to the guiding support elements 28a, 28b).

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A penetrometer comprising:
a hammer;
an anvil;
a penetrating rod extending from the anvil with the anvil between the hammer and the penetrating rod; and
an automated actuator engaged with the hammer and configured to reciprocally impact the hammer against the anvil, the automated actuator being weight-supported by the anvil through the hammer with the penetrometer positioned with the automated actuator above the anvil and upon impact of the hammer against the anvil.

2. The penetrometer of claim 1 wherein the hammer includes a shaft and a head distally disposed between the shaft and the anvil, the shaft being engaged with the automated actuator.

3. The penetrometer of claim 1 wherein the automated actuator is electrical in nature.

4. The penetrometer of claim 3 wherein the automated actuator is a solenoid device.

5. The penetrometer of claim 1 wherein the automated actuator includes a control module, the control module being weight-supported by the anvil through the hammer with the penetrometer positioned with the control module above the anvil and upon impact of the hammer against the anvil.

6. The penetrometer of claim 1 wherein the automated actuator includes a power source, the power source being weight-supported by the anvil through the hammer with the penetrometer positioned with the power source above the anvil and upon impact of the hammer against the anvil.

7. The penetrometer of claim 1 further includes a guiding support slidably engaged with the automated actuator.

8. The penetrometer of claim 7 wherein the guiding support includes two guiding support elements each being slidably engaged with the automated actuator.

9. The penetrometer of claim 7 wherein the guiding support is rod-shaped.

10. The penetrometer of claim 7 wherein the guiding support is slidably engaged with the anvil.

11. The penetrometer of claim 10 wherein the guiding support includes two guiding support elements each being slidably engaged with the anvil.

12. The penetrometer of claim 1 wherein the automated actuator is weight-supported by the anvil with the penetrometer positioned with the automated actuator above the anvil and with the hammer not in contact with the anvil.

13. The penetrometer of claim 12 further includes a spacer element engaged with the automated actuator disposed between the automated actuator and the anvil, the automated actuator being weight-supported by the anvil through the spacer element with the penetrometer positioned with the automated actuator above the anvil.

14. The penetrometer of claim 13 further includes a spring disposed between the spacer element and anvil, the automated actuator being weight supported by the anvil through the spring with the penetrometer positioned with the automated actuator above the anvil.

15. The penetrometer of claim 1 further includes a spring disposed between the automated actuator and the anvil, the automated actuator being weight-supported by the anvil through the spring with the penetrometer positioned with the automated actuator above the anvil.

16. The penetrometer of claim 15 further includes a guiding support slidably engaged with the automated actuator, the spring being coiled about the guiding support.

17. A penetrometer comprising:
a hammer;
an anvil;
a penetrating rod extending from the anvil with the anvil between the hammer and the penetrating rod; and
an automated actuator engaged with the hammer and configured to reciprocally impact the hammer against the anvil, the automated actuator being weight-supported by the anvil with the penetrometer positioned with the automated actuator above the anvil and with the hammer not in contact with the anvil.

18. The penetrometer of claim 17 further includes a spacer element engaged with the automated actuator disposed between the automated actuator and the anvil, the automated actuator being weight-supported by the anvil through the spacer element with the penetrometer positioned with the electrical actuator above the anvil.

19. The penetrometer of claim 18 further includes a spring disposed between the spacer element and anvil, the automated actuator being weight-supported by the anvil through the spring with the penetrometer positioned with the automated actuator above the anvil.

20. The penetrometer of claim 17 further includes a spring disposed between the automated actuator and the anvil, the automated actuator being weight-supported by the anvil through the spring with the penetrometer positioned with the automated actuator above the anvil.
